(19) United States
(12) Patent Application Publication
(10) Pub. No.: US 2024/0302098 A1
(43) Pub. Date: Sep. 12, 2024

(54) PADDLE SWEEP ASSEMBLY

(71) Applicant: THE SHIVVERS GROUP, INC., Corydon, IA (US)

(72) Inventors: Nathan P. Erickson, Edgar, WI (US); Patrick Heller, St. Cloud, MN (US); Richard D. Crawford, Unionville, MO (US)

(21) Appl. No.: 18/598,649

(22) Filed: Mar. 7, 2024

Related U.S. Application Data
(60) Provisional application No. 63/488,906, filed on Mar. 7, 2023.

(51) Int. Cl. F26B 17/20; F26B 25/00

(52) U.S. Cl. CPC F26B 17/20; F26B 25/002; F26B 2200/06

(57) ABSTRACT

A paddle sweep assembly has a top, a bottom, a front and a back. Adjacent to the center of a bin is a drive mechanism connected to a drive sprocket. A continuous chain is mounted about the drive sprocket and extends from the drive sprocket to at least one outer sprocket. Attached to the chain are a plurality of paddles. The paddles are angled about their horizontal axis and are cut and rotated so as not to be perpendicular with the chain. The paddles are configured to pull grain toward a sump on the bottom side of the paddle sweep assembly and away from the center of the bin on the top side of the paddle sweep assembly. The paddles are also angled in relation to the chain so that on the back side the grain slides off the paddles and onto the floor of the bin.

### CROSS REFERENCE TO RELATED APPLICATION

This application claims the benefit of U.S. Provisional Application Ser. No. 63/488,906 filed Mar. 7, 2023, the contents of these applications are hereby incorporated by reference in their entirety.

### BACKGROUND OF THE INVENTION

The present invention is directed to a sweep assembly and more particularly to a paddle sweep assembly used in the process of drying grain in a bin.

The process of drying grain is complex and prevents many challenges. With respect to quality control one wishes to avoid incomplete, improper and over-drying situations that can negatively influence the acceptance of grain by consumers. Dried grain moisture content is a critical factor for developing grain drying systems and selecting optimal performance. Also, over drying beyond a desired moisture level will consume extra energy.

The drying time in the grain drying process largely depends on aeration rates. Without sufficient airflow, grain may be damaged before drying is complete. Weather conditions at harvest often results in “tough” or damp grain that must be dried to avoid spoiling in storage. Most grain is dried using high-temperature air, which can result in stress cracks, heat damage, and quality loss.

These challenges highlight the need for efficient, energy-saving, and quality-preserving grain drying technologies. Paddle sweeps have been used to remove grain more gently than sweep augers but not used to bring grain into the bin and provide an even unpacked layer of grain. This paddle sweep will be used to bring grain into the bin, assist in the drying process by potentially mixing the grain by an additional pass around the bin and to remove the grain once dry. This paddle sweep will also be used to empty the bin when used as a storage bin.

### SUMMARY OF THE INVENTION

A paddle sweep assembly has a top, a bottom, a front side and a back side. A drive mechanism is positioned adjacent a center of a bin that is connected to a drive sprocket. A continuous chain is mounted about the drive sprocket and extends from the drive sprocket to at least one outer sprocket. A plurality of paddles are attached to the chain. The paddles are angled about their horizontal axis and are cut and rotated so as not to be perpendicular with the chain.

The paddles are configured to pull grain toward a sump on the bottom side of the paddle sweep assembly and away from the center of the bin on the top side of the paddle sweep assembly. The paddles are angled in relation to the chain on the back side of the paddle sweep assembly to cause the grain to slide off the paddles and onto the floor of the bin. The paddle sweep assembly is tipped on its horizontal axis so that grain will slide out of the paddle sweep assembly at a selected height as the back side of the paddle sweep assembly continues to fill with grain out to an outer wall of the bin.

The paddle sweep assembly also has a center vertical tube with a slip ring, a drive motor, a wheel motor and sensors. There is also a fill tube positioned to direct incoming grain into the paddle sweep assembly along with a rotating ring tube and a circular shield. There is also a shroud positioned adjacent the outer wall of the bin.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

An objective of the present invention is to provide a paddle sweep assembly that efficiently dries and removes grain from a bin while minimizing grain damage and energy consumption.

Another objective of the present invention is to provide a paddle sweep assembly that has an angle and orientation to more effectively distribute incoming wet grain evenly and direct the outgoing dry grain to the sump.

These and other objectives will be apparent to one of ordinary skill in the art based upon the following written description, claims and drawings.

### BRIEF DESCRIPTION OF THE DRAWINGS

FIG. 1 is a rear perspective view of a sweep assembly according to an aspect of the disclosure;

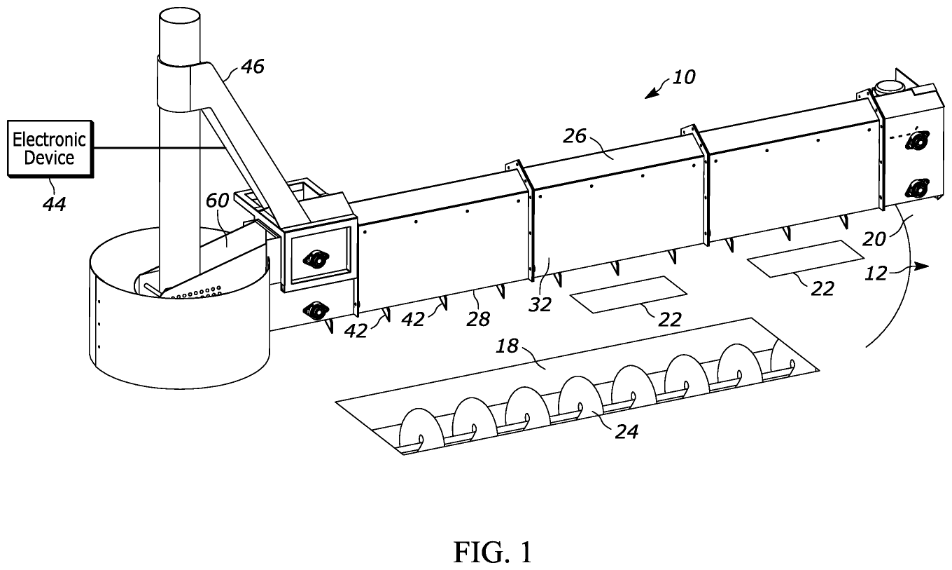

FIG. 2 is a bottom perspective view of a sweep assembly according to an aspect of the disclosure;

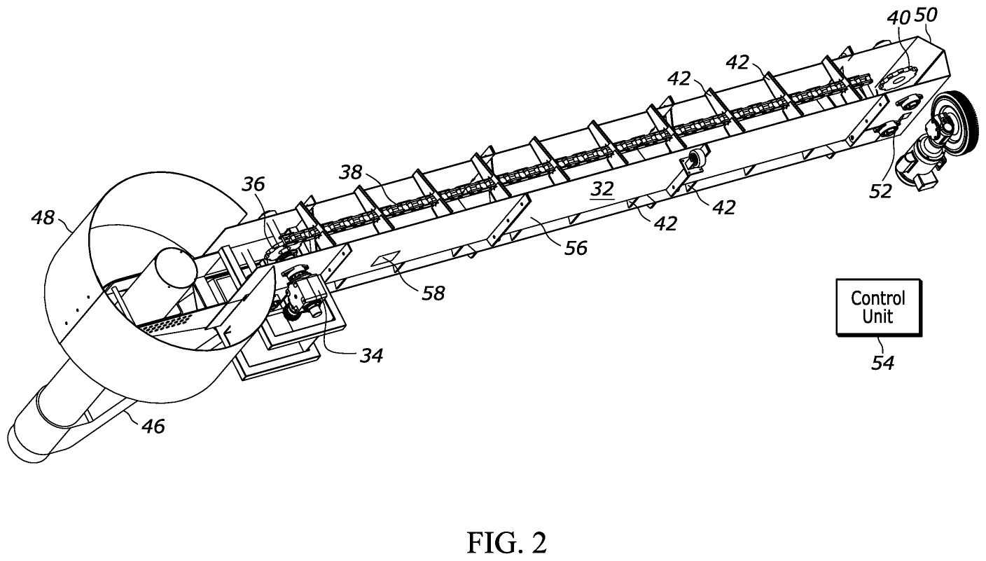

FIG. 3 is a rear view of a sweep assembly according to an aspect of the disclosure; and

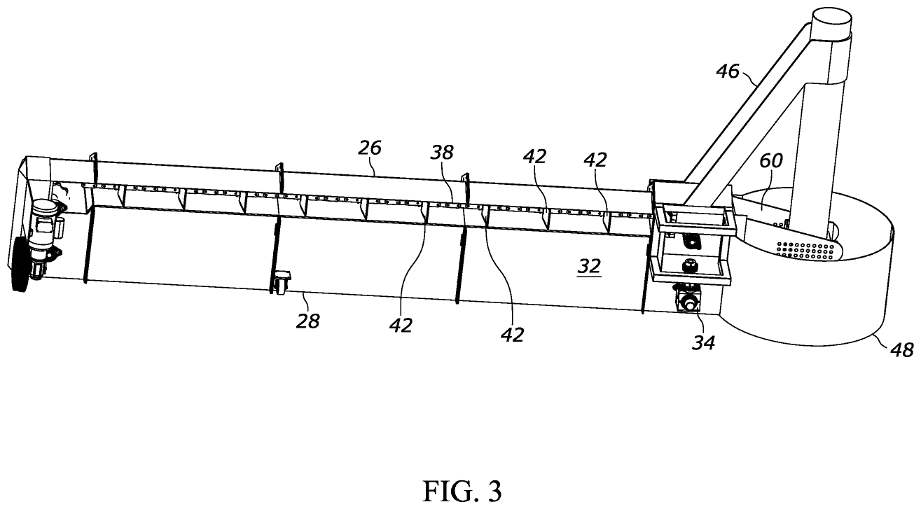

FIG. 4 is a front perspective view of a sweep assembly according to an aspect of the disclosure.

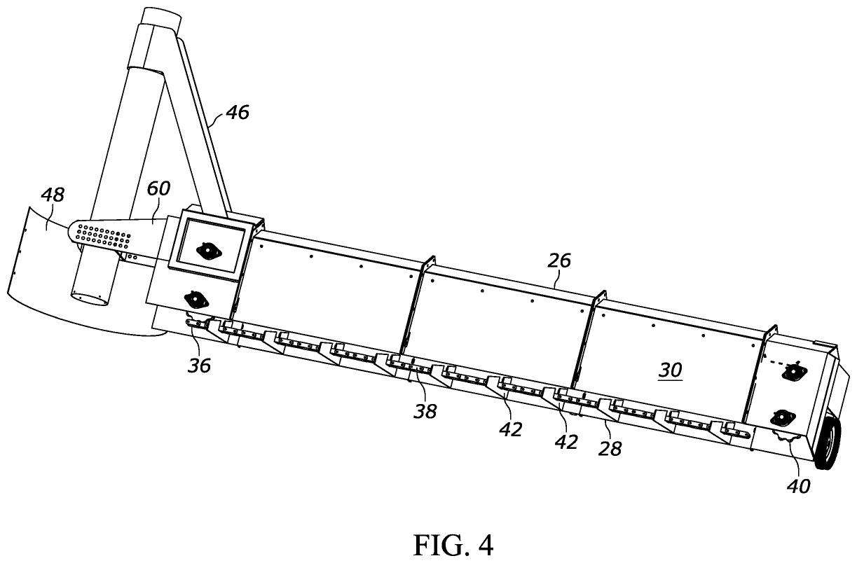

### DETAILED DESCRIPTION

A paddle sweep assembly 10 is installed within a bin 12. At the center 14 of the bin is a sump 16 and a perforated floor 18 extends from the center 14 of the bin 12 to an outer wall 20. Between the center 14 of the bin and the outer wall 20 are a plurality of secondary sumps 22. The sump 16 and secondary sumps 22 feed to an output auger 24 for transporting grain out of the bin 12.

The paddle sweep assembly 10 has a top 26, a bottom 28, a front 30 and a back 32. A drive mechanism 34 is positioned adjacent the center of the bin 12 and is connected to a drive sprocket 36 and a tensioning sprocket is also included. A continuous chain 38 is mounted about the drive sprocket 36 and extends from the drive sprocket 36 to one or two outer sprockets 40 adjacent the outer wall 20 of the bin 12. Attached to the chain 38 are a plurality of paddles 42. The paddles and track 10 are tipped or angled on its horizontal axis and the paddles 42 are cut and rotated in a manner so that they are not perpendicular to the chain 38. Additionally, the paddles could be horizontal and not tipped. The grain is pulled toward the sump 16 on the bottom side 28 and away from the center 14 of the bin 12 on the top side 26. On the back side 32 the paddles are angled in relation to the chain 38 to cause grain to slide off onto the floor 18. The paddle sweep assembly 10 is tipped on its horizontal axis, which allows the grain to slide out of the paddle sweep assembly 10 at a given height, such as 18 inches, with the option to add a drag to change the height of the grain either manually or some other method so it could adapt to the optimal height of the grain dependent on incoming moisture content for drying and will continue to fill the back side of the sweep all the way to the outer wall 20 of the bin and will fill the whole circumference of the bin with a predetermined height.

On a center vertical tube is a slip ring to provide power to the drive motor, drive wheel motor, sensors and any other electronic devices 44. There also is a funnel or fill tube 46 that is positioned and oriented to feed incoming grain into the sweep assembly 10. Associated with the fill tube 46 is a rotating ring tube 48 that will direct grain into the sweep assembly 10 regardless of the location of the sweep assembly 10 within the bin 12. Also attached to the sweep is a large circular shield that will turn with the sweep and prevent the wet grain from falling into the sump but will allow an opening that allows the dry grain that is being swept by the sweep to be pulled into the sump. Also, adjacent the outer wall 20 of the bin 12 is an assembly that includes a shield or shroud 50 used to separate wet and dry grain and cause any grain that has not fallen off the floor of the sweep 18 to be captured and directed to the back (wet) side 32 of the sweep, mounts for the sprockets, and a diverter surface that will bring grain from the outer edge of the front side of the sweep into the lower paddle area to be removed to assist in removing grain from the perimeter of the bin.

In operation, wet grain is brought into the bin 12 and is distributed evenly at a predetermined depth, about 18 inches, by utilizing the paddles 42 on the top side 26 of the sweep 10 that move away from the center 14 of the bin 12. Grain is dropped from the center 14 of the bin 12 into the funnel tube 46 and the rotating ring 48 directs the grain into the sweep assembly 10 regardless of the location of the sweep assembly 10 within the bin 12. As the top floor of the sweep assembly and the angle of the paddles will encourage the grain to slide out of the sweep assembly 10 at a predetermined height and will continue to fill the back side 32 of the sweep assembly 10 all the way to the outer wall 20 of the bin 12 at which point a trip sensor 52 is activated to cause a drive wheel (not shown) to advance the sweep assembly 10 until the sensor 52 is no longer activated and then the process is repeated to fill the circumference of the bin 12 at the predetermined height. Once the sweep assembly 10 has made a complete trip around the bin 12 both fans and dryers (not shown) will be activated to dry the grain. A control unit 54 is connected to the sweep drive mechanism, sensor 52 and the drive wheel, fans, and dryers (not shown).

Next, based on a predetermined setting, the control unit 54 activates the sweep assembly 10 to sample the grain on the front side 30 of the sweep assembly 10. The paddles 42 bring the grain into the sweep and are oriented to pull the grain against a back wall 56 of the sweep assembly 10 where a moisture sensor or sensors 58 are mounted. If the grain has more moisture than a predetermined setting, the control unit 54 will stop the sweep assembly 10. If the grain has less moisture than the predetermined setting the control unit 54 will direct the grain to the center 14 of the bin and into the sump 16 where the grain will be removed from the bin via the output auger 24 or similar device.

While sampling the grain a shield 60 will be rotated to prevent wet grain from entering the sump 16 and instead will direct the grain around the top 26 of the sweep assembly 10 to be redistributed to the wet front side 30 of the sweep assembly 10. It will also prevent additional wet grain from coming into the bin and the sweep. An additional option would be for the sweep assembly to make another complete revolution around the bin when the grain is at a predetermined dryness to mix the grain for more even drying before removing the grain from the bin 12. Both the front 30 and back 32 side of the sweep assembly 10 will always have grain present to prevent air from blowing up through the floor 18. Thus, forward advancement of the sweep assembly 10 is always controlled based on the back side sensor indicating it is full and the moisture of the front side is dried to a predetermined level before the sweep assembly can be advanced. All grain will need to fall off the top 26 of the sweep assembly 10 before it gets to the outer end to prevent the wet grain from entering the dry front side 32. The shroud 50 is positioned to assist in separating the grain that is carried to the outer end. An additional advantage of this process is that there will be a temporary void under the sweep only where the paddles will be removing the grain allowing additional airflow through the perforated floor in that immediate area cleaning the debris from the floor making the whole system more efficient by removing obstructions to air flow.

Once the drying is completed, to fill the bin, the sweep assembly will be directed to a designated parking area near the secondary sumps 22 by the control unit once the bin is filled. At this point, the grain is emptied via the sumps 16, 22 as the sweep assembly 10 rotates about the bin until the bin is empty.

From the above discussion and accompanying figures and claims it will be appreciated that the paddle sweep assembly 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A paddle sweep assembly comprising:
a top, a bottom, a front and a back;
a drive mechanism positioned adjacent a center of a bin that is connected to a drive sprocket;
a continuous chain mounted about the drive sprocket that extends from the drive sprocket to at least one outer sprocket;
a plurality of paddles attached to the chain;
wherein the paddles are angled about their horizontal axis and are cut and rotated so as not to be perpendicular with the chain.

2. The assembly of claim 1 wherein the paddles are configured to pull grain toward a sump on the bottom side of the paddle sweep assembly and away from the center of the bin on the top side of the paddle sweep assembly.

3. The assembly of claim 1 wherein the paddles are angled in relation to the chain on the back side of the paddle sweep assembly to cause the grain to slide off the paddles and onto a floor of the bin.

4. The assembly of claim 1 wherein the paddle sweep assembly is tipped on its horizontal axis so that grain will slide out of the paddle sweep assembly at a selected height as the back side of the paddle sweep assembly continues to fill with grain out to an outer wall of the bin.

5. The assembly of claim 1 further comprising a center vertical tube having a slip ring, a drive motor, a wheel motor, and sensors.

6. The assembly of claim 1 further comprising a fill tube positioned to direct incoming grain into the paddle sweep assembly.

7. The assembly of claim 6 further comprising a rotating ring tube.

8. The assembly of claim 1 further comprising a circular shield.

9. The assembly of claim 4 further comprising a shroud positioned adjacent the outer wall of the bin.
